(19) United States
(12) Patent Application Publication
(10) Pub. No.: US 2014/0077697 A1
(43) Pub. Date: Mar. 20, 2014

(54) LED Lamp

(71) Applicant: Beat-Sonic Co., Ltd., Nisshin-shi (JP)

(72) Inventor: Tsutomu Totani, Nisshin-shi (JP)

(73) Assignee: Beat-Sonic Co., Ltd., Nisshin-shi (JP)

(21) Appl. No.: 13/974,260

(22) Filed: Aug. 23, 2013

(30) Foreign Application Priority Data
Sep. 19, 2012 (JP) 2012-205220

(51) Int. Cl. H05B 33/08

(52) U.S. Cl. CPC H05B 33/0842
USPC 315/50

(57) ABSTRACT

An LED lamp includes a heat dissipator having two ends, a module substrate which is fixed to one end of the heat dissipator and on which an LED chip is mounted, a cap mounted via a cylindrical insulator on the other end of the heat dissipator, a lighting circuit which is disposed in the heat dissipator and/or the cap to supply electric power to the LED chip, the lighting circuit being electrically connected to the cap, and a dimming volume having a rotating shaft and variably adjusting an amount of light or a color temperature of the LED chip according to an amount of rotation of the rotating shaft, the rotating shaft being operably mounted on the heat dissipator or the insulator.

### CROSS-REFERENCE TO RELATED APPLICATIONS

This application is based upon and claims the benefit of priority from the prior Japanese Patent Application No. 2012-205220 filed on Sep. 19, 2012, the entire contents of which are incorporated herein by reference.

### BACKGROUND

1. Technical Field

The present disclosure relates to an LED lamp incorporating an LED chip serving as a light source.

2. Related Art

Demand for LED lamps or LED light bulbs has recently been increasing as substitute for incandescent lamps having higher electrical power consumption. This type of LED lamp is disclosed by Japanese Patent Application Publication Nos. JP-A-2011-70972, JP-A-2011-82132, JP-A-2011-90828 and JP-A-2011-91033, for example. As disclosed, the LED lamp includes a module substrate on which an LED chip is mounted and which is fixed to one end of a heat dissipator made of a metal, such as aluminum, having high heat conductivity and high radiation performance. The LED lamp further includes a transparent or translucent glove which is attached to the heat dissipator so as to cover the module substrate, a cap mounted on the other end of the heat dissipator and a lighting circuit which supplies electric power to the LED chip and is incorporated in the heat dissipator. The lighting circuit and the cap are electrically connected to each other.

Furthermore, Japanese Patent Application Publication Nos. JP-A-2004-363061, JP-A-2011-175793 and JP-A-2011-222723 disclose illuminating devices which use an LED chip as a light source and in which an amount of light and color temperature of the LED chip are adjustable.

The above-described conventional LED lamp includes the cap having a shape and dimensions both conforming to the International Standard. Accordingly, the LED lamp can be connected to a socket or a lamp holder mounted on a ceiling or wall surface in the same manner as an incandescent lamp. The LED lamp of the above-described type is standardized so as to emit illumination light with a predetermined luminance or a predetermined color temperature in the same manner as an incandescent lamp. Accordingly, the currently used LED lamp needs to be replaced by a new LED lamp having different specification in order that the luminance or color temperature of the illumination light may be changed, with the result that the LED lamp is inconvenient.

On the other hand, the above-described illuminating device having an LED chip as the light source is adjustable in an amount of light and a color temperature. However, the illuminating device is not detachably attachable to the socket mounted on the ceiling or wall surface, differing from the LED lamp. Thus, the illuminating device increases construction costs required for installation thereof.

### SUMMARY

Therefore, an object of the disclosure is to provide an LED lamp which can change luminance and color temperature by a simpler operation and which can expand the use as an illuminating device.

The present disclosure provides an LED lamp comprising a heat dissipator having two ends, a module substrate which is fixed to one end of the heat dissipator and on which an LED chip is mounted, a cap mounted via a cylindrical insulator on the other end of the heat dissipator, a lighting circuit which is disposed in the heat dissipator and/or the cap to supply electric power to the LED chip, the lighting circuit being electrically connected to the cap, and a dimming volume having a rotating shaft and variably adjusting an amount of light or a color temperature of the LED chip according to an amount of rotation of the rotating shaft, the rotating shaft being operably provided on the heat dissipator or the insulator.

In the above-described construction, the dimming volume has a rotating shaft and variably adjusts an amount of light or a color temperature of the LED chip according to an amount of rotation of the rotating shaft. The rotating shaft is provided on the heat dissipator or the insulator. Accordingly, the luminance and the color temperature of the illumination light by rotating the rotating shaft of the dimming volume without replacement of the LED lamp. This can expand the use as an illuminating device.

The disclosure also provides an LED lamp comprising a heat dissipator having two ends, a module substrate which is fixed to one end of the heat dissipator and on which an LED chip is mounted, a cap mounted via a cylindrical insulator on the other end of the heat dissipator, a lighting circuit which is disposed in the heat dissipator and/or the cap to supply electric power to the LED chip, the lighting circuit being electrically connected to the cap, and a change-over switch which is configured to change an amount of light or a color temperature of the LED chip, the change-over switch being operably provided on the heat dissipator or the insulator.

In the above-described construction, the change-over switch which changes an amount of light or a color temperature of the LED chip. The change-over switch is provided on the heat dissipator or the insulator. Accordingly, the luminance and the color temperature of the illumination light can be changed by switching the change-over switch without replacement of the LED lamp. This can also expand the use as an illuminating device.

### BRIEF DESCRIPTION OF THE DRAWINGS

In the accompanying drawings:

FIG. 1 is a sectional view of an LED lamp according to a first embodiment;

FIG. 2 is a circuit diagram of a lighting circuit of the LED lamp;

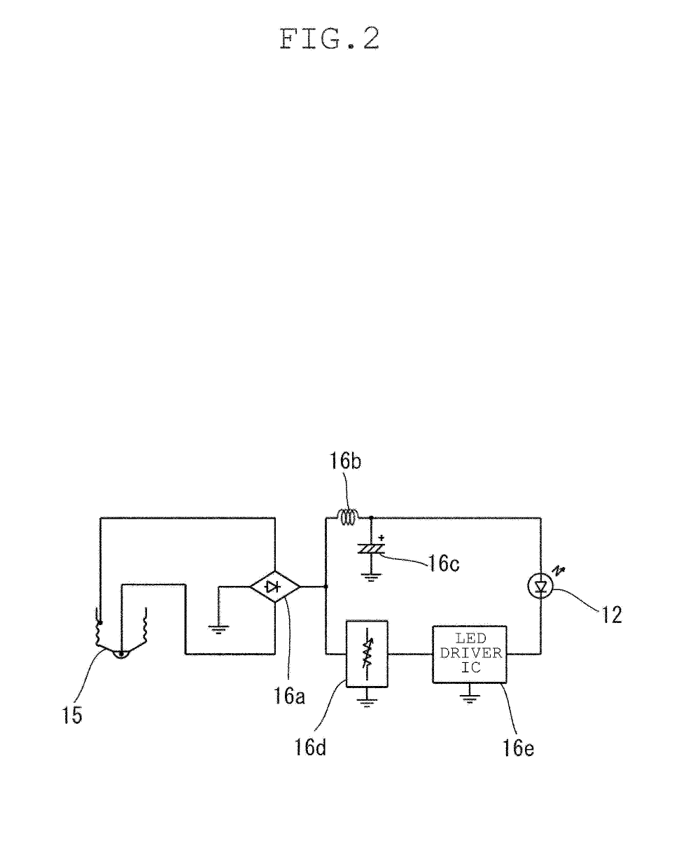

FIG. 3 is a circuit diagram of a lighting circuit of the LED lamp according to a second embodiment;

FIG. 4 is a sectional view of the LED lamp according to a third embodiment;

FIG. 5 is a circuit diagram of a lighting circuit of the LED lamp according to the third embodiment;

FIG. 6 is a sectional view of the LED lamp according to a fourth embodiment; and

FIG. 7 is a sectional view of the LED lamp according to a fifth embodiment.

### DETAILED DESCRIPTION

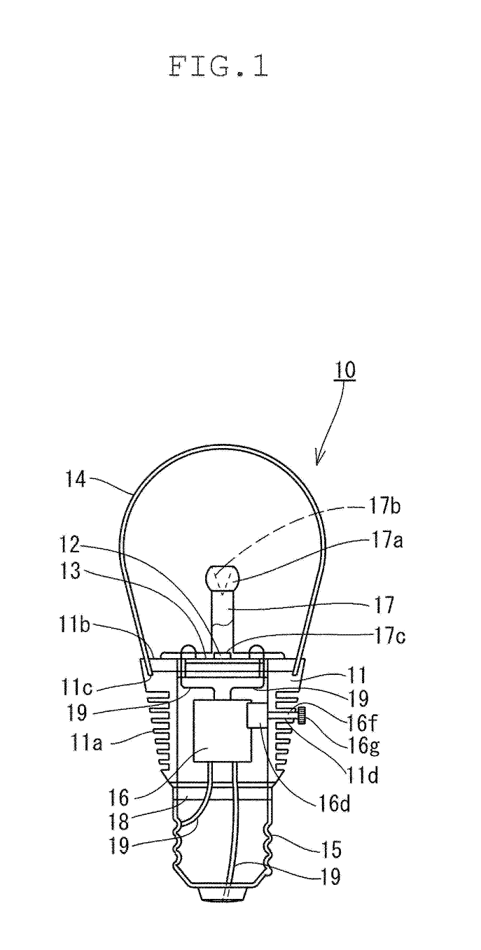

Several embodiments will be described with reference to the accompanying drawings. Referring to FIG. 1, an LED lamp 10 according to a first embodiment is shown. The LED lamp 10 includes a heat dissipator 11 made of a metal, such as aluminum, an LED chip 12 mounted on a module substrate 13 on which an LED chip 12 is mounted, a translucent dome-shaped glove 14 made of glass or resin, a cap 15, a lighting circuit 16 which supplies electric power to the LED chip 12, and a light guide member 17.

The heat dissipator 11 is formed into the shape of a generally inverted truncated cone and has an outer periphery formed with a number of fins 11a which increase a surface area in order to enhance a heat radiation effect. The module substrate 13 is fixed to an upper end surface of the heat dissipator 11. The cap 15 is attached via a cylindrical insulator 18 to a lower open end of the heat dissipator 11, whereby an interior of the heat dissipator 11 communicates with an interior of the cap 15. The lighting circuit 16 is disposed in the interiors of the heat dissipator 11 and the cap 15. The module substrate 13 and the lighting circuit 16 are electrically connected together by a lead wire 19. The lighting circuit 16 and the cap 15 are also connected together by another lead wire 19.

The lighting circuit 16 supplying electric power to the LED chip 12 is constructed of a rectifying circuit 16a, a smoothing circuit including a choke coil 16b and a capacitor 16c, a dimming volume 16d and an LED driver IC 16e. The rectifying circuit 16a is configured to rectify an AC current supplied from the socket 15. Output current pulses of the rectifying circuit 16a are reduced by the smoothing circuits 16b and 16c thereby to be supplied via the dimming volume 16d to the LED driver IC 16e. The LED driver IC 16e is configured to apply the output current to the LED chip 12. Thus, volume voltage applied to the LED chip 12 by the dimming volume 16d is adjusted, whereby the luminance of the illumination light emitted from the LED lamp 10 can be changed.

The heat dissipator 11 has a ring groove 11c which is formed in an upper end surface 11b thereof so as to surround the module substrate 13. The glove 14 includes a lower open end which is fitted in the ring groove 11c and then secured to the heat dissipator 11 by an adhesive agent. The glove 14 is detachably attached to the heat dissipator 11 so as to cover the module substrate 13. The columnar light guide member 17 is fixed to the module substrate 13 fixed to the upper end 11b of the heat dissipator 11, so as to stand thereon. The light guide member 17 is a plastic molding and has a distal end having a reflecting part 17a which has an inner surface formed with a square pyramidal reflecting surface 17b. On the other hand, the light guide member 17 has a proximal end formed with a recess 17c and is attached to the module substrate 13 so that the recess 17c covers the LED chip 12. Light emitted from the LED chip 12 opposed to the recess 17c enters the light guide member 17 from the recess 17c and is then reflected on the reflecting surface 17b thereby to be diffused around the reflecting part 17a.

The dimming volume 16d of the lighting circuit 16 is fixed to the inner surface of the heat dissipator 11. The dimming volume 16d has a rotating shaft 16f inserted through a through hole 11d formed in the heat dissipator 11. The rotating shaft 16f has a distal end on which a dimming knob 16g is mounted.

In the LED lamp 10 constructed as described above, the dimming knob 16g is rotated so that voltage applied to the LED chip 12 is variably adjusted, whereby the luminance of illumination light emitted by the LED lamp 10 is changeable. Accordingly, the luminance of illumination light is variably adjustable without replacement of the LED lamp 10 by another lamp having a different specification. This can expand the use as an illuminating device.

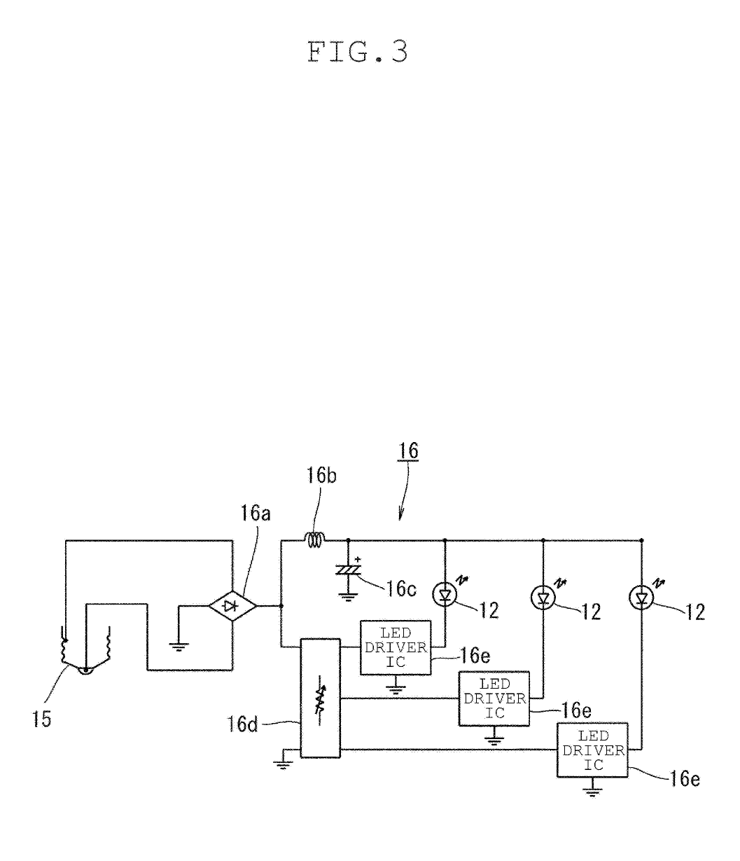

FIG. 3 shows a circuit arrangement of the lighting circuit 16 of the LED lamp according to a second embodiment. The lighting circuit 16 is constructed of the rectifying circuit 16a, the smoothing circuits 16b and 16c, the dimming volume 16d, three LED driver ICs 16e and three LED chips 12 connected to the LED driver ICs 16e respectively. The LED chips 12 are selected so as to have different emission colors (spectra). The lighting circuit 16 can variably adjust ratios between voltages applied to the respective LED chips 12 by the dimming volume 16d. Amounts of light of the respective LED chips 12 are varied by changing the ratios between voltages applied to the respective LED chips 12. Amounts of light of the respective LED chips 12 are varied by changing the ratios between voltages applied to the respective LED chips 12. This changes a percentage of luminous flux of each LED chip 12 in a mixed luminous flux of light emitted by the three LED chips 12, with the result that a color temperature of the LED lamp is changeable by rotating the dimming knob 16g of the dimming volume 16d.

The LED lamp according to the second embodiment has the same structure as that according to the first embodiment in the other respect than described above. Accordingly, a sectional view of the LED lamp is eliminated in the second embodiment.

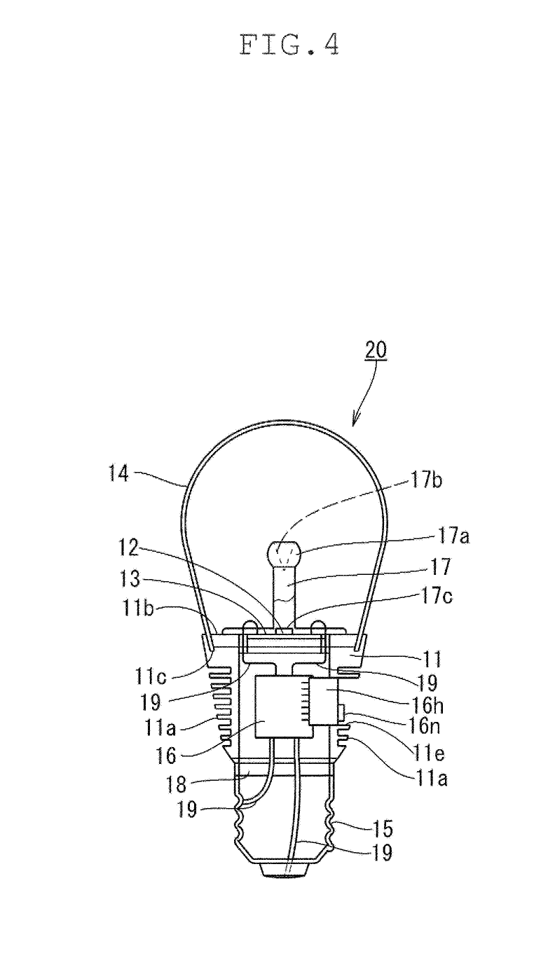

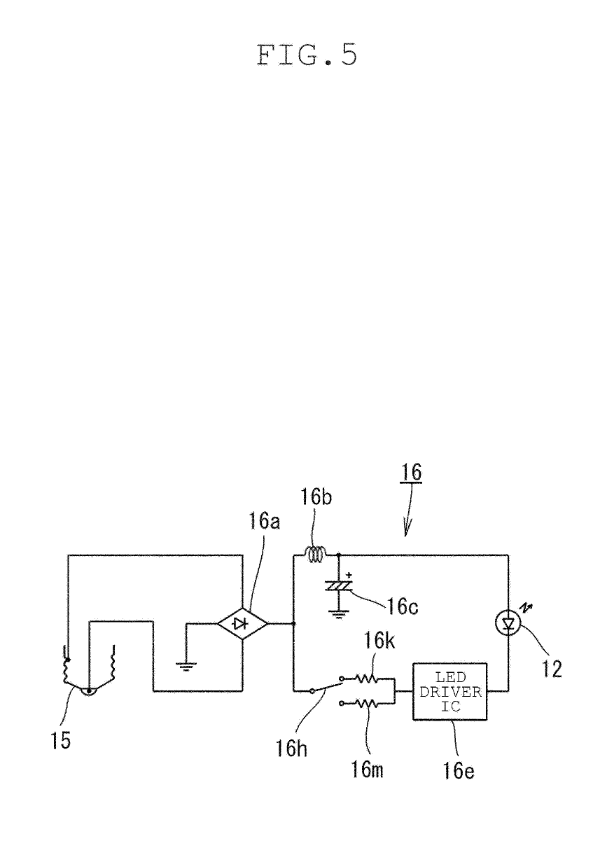

FIG. 4 illustrates the LED lamp 20 according to a third embodiment. FIG. 5 illustrates a circuit arrangement of the lighting circuit 16 of the LED lamp 20 according to the third embodiment. Although the lighting circuit 11 is provided with the dimming volume in the first embodiment, a change-over switch 16h and two resistances 16k and 16m having different resistance values in the third embodiment. When the change-over switch 16h is connected to the resistance 16k and 16m, voltage applied to the LED chip 12 is varied with the result that the luminance of illumination light of the LED lamp 20 can be changed.

The lighting circuit 16 has the same configuration as the lighting circuit of the first embodiment in the other respects than described above. Accordingly, identical or similar parts are labeled by the same reference symbols as those in the first embodiment. The detailed description of these parts will be eliminated.

As shown in FIG. 4, the change-over switch 16h is fixed to the inner surface of the heat dissipator 11, and the heat dissipator 11 has a through hole 11e out of the heat dissipator 11. A knob 16n of the change-over switch 16h protrudes through the opening 11e out of the heat dissipator 11. When the knob 16n is slid upward and downward in the opening 11e, the switch 16h is connected to the resistance 16k or 16m.

The lighting circuit 16 has the same configuration as the lighting circuit of the first embodiment in the other respects than described above. Accordingly, identical or similar parts are labeled by the same reference symbols as those in the first embodiment. The description of these parts will be eliminated

In the LED lamp 20 constructed as described above, the knob 16n of the change-over switch 16h is slid to change voltage applied to the LED chip 12, whereby the luminance of illumination light of the LED lamp 20 can be changed. Accordingly, the luminance of illumination light is variably adjustable without replacement of the LED lamp 10 by another lamp having a different specification. This can expand the use as an illuminating device.

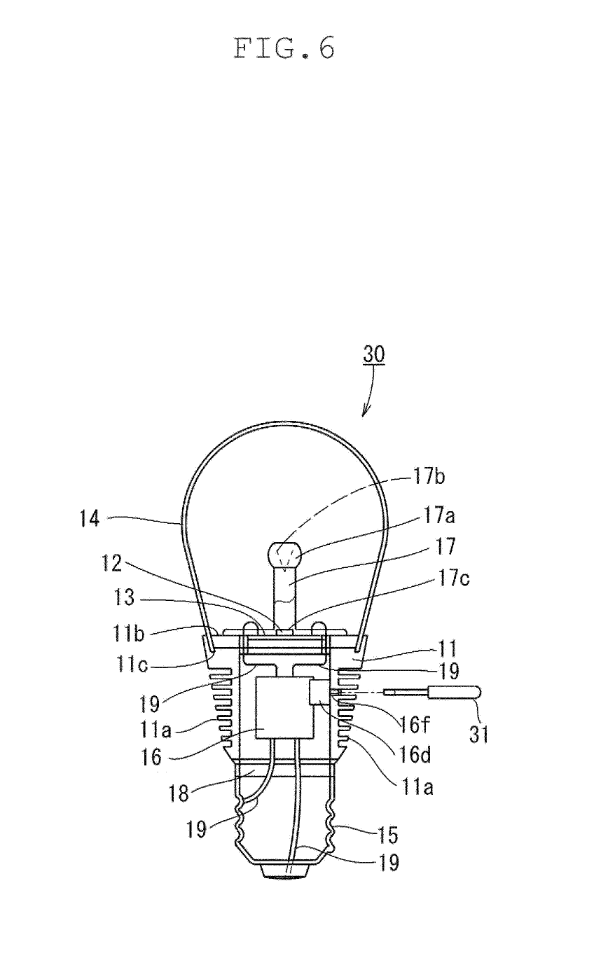

FIG. 6 shows an LED lamp 30 according to a fourth embodiment. The dimming knob 16g is mounted on the distal end of the rotating shaft 16f of the dimming volume 16d in the LED lamp 10 according to the first embodiment. In the fourth embodiment, no dimming knob 16g is mounted on the distal end of the rotating shaft 16f in the LED lamp 30. A linear groove is formed in the distal end of the rotating shaft 16f. A flat-blade driver 31 is inserted into the groove to rotate the rotating shaft 16f, whereby the luminance of the LED lamp 30 is variably changeable.

The LED lamp 20 has the same configuration as the lighting circuit of the first embodiment in the other respects than described above. Accordingly, identical or similar parts are labeled by the same reference symbols as those in the first embodiment. The description of these parts will be eliminated.

In the LED lamp 30 according to the fourth embodiment, since the dimming knob 16g does not make an appearance of the LED lamp 30, the appearance can be simplified.

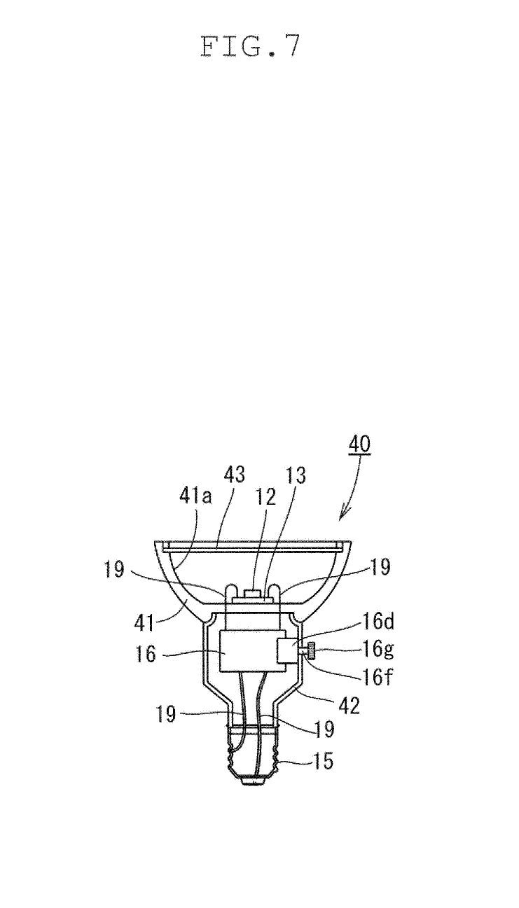

FIG. 7 shows the LED lamp 40 according to a fifth embodiment. The LED lamp 40 includes a cup-shaped heat dissipator 41 made of aluminum, a cylindrical insulator 42 made of an insulating material and the cap 15. The cup-shaped heat dissipator 41 has a bottom to which one end of the insulator 42 is fixed. The cap 15 is attached to the other end of the insulator 42. The heat dissipator 41 has a reflection layer 41a formed on the inner circumferential surface thereof. A transparent cover plate 43 made of an acrylic resin is attached to the open end of the heat dissipator 41. The module substrate 13 on which the LED chip 12 is mounted is fixed to the central bottom of the heat dissipator 41. The lighting circuit 16 supplying electric power to the LED chip 12 is incorporated in the insulator 42. The module substrate 13 and the lighting circuit 16 are electrically connected together by the lead wire 19. The lighting circuit 16 and the cap 15 are also connected together by another lead wire 19.

The lighting circuit 16 has the same circuit arrangement as that in the first embodiment. The rotating shaft 16f of the dimming volume 16d is inserted through the through hole formed in the insulator 42. The dimming knob 16g is mounted on the distal end of the rotating shaft 16f.

In the LED lamp 40 constructed as described above, the knob 16g is rotated to variably adjust voltage applied to the LED chip 12, with the result that the luminance of spot illumination light can be changed.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An LED lamp comprising:
a heat dissipator having two ends;
a module substrate which is fixed to one end of the heat dissipator and on which an LED chip is mounted;
a cap mounted via a cylindrical insulator on the other end of the heat dissipator;
a lighting circuit which is disposed in the heat dissipator and/or the cap to supply electric power to the LED chip, the lighting circuit being electrically connected to the cap; and
a dimming volume having a rotating shaft and variably adjusting an amount of light or a color temperature of the LED chip according to an amount of rotation of the rotating shaft, the rotating shaft being operably provided on the heat dissipator or the insulator.

2. An LED lamp comprising:
a heat dissipator having two ends;
a module substrate which is fixed to one end of the heat dissipator and on which an LED chip is mounted;
a cap mounted via a cylindrical insulator on the other end of the heat dissipator;
a lighting circuit which is disposed in the heat dissipator and/or the cap to supply electric power to the LED chip, the lighting circuit being electrically connected to the cap; and
a change-over switch which is configured to change an amount of light or a color temperature of the LED chip, the change-over switch being operably provided on the heat dissipator or the insulator.
